(19) United States
(12) Patent Application Publication
(10) Pub. No.: US 2025/0165552 A1
(43) Pub. Date: May 22, 2025

(54) PARALLEL EVOLUTIONARY SOLUTION METHOD FOR SEARCH SPACE SEGMENTATION

(71) Applicant: CHINA UNIVERSITY OF MINING AND TECHNOLOGY, Xuzhou City (CN)

(72) Inventors: Mingcheng ZUO, Xuzhou City (CN); Dunwei GONG, Xuzhou City (CN)

(73) Assignee: CHINA UNIVERSITY OF MINING AND TECHNOLOGY, Xuzhou City, JS (CN)

(21) Appl. No.: 18/747,479

(22) Filed: Jun. 19, 2024

(30) Foreign Application Priority Data
Nov. 20, 2023 (CN) 2023115565738

(51) Int. Cl. G06F 17/11

(52) U.S. Cl. CPC G06F 17/11

(57) ABSTRACT

The invention discloses a parallel evolutionary solution method for search space segmentation, comprising: S1, randomly generating solution schemes via a search space sampling and segmentation module, calculating fitness values by combining initial sample schemes with an optimization objective function, statistically screening sample schemes, determining the dimension direction K of the segmented search space, and dividing the search space into subspaces; S2, executing a global search algorithm in the segmented subspaces to obtain a global initial solution scheme; S3, using the global initial solution scheme as a starting point, obtaining a precise solution scheme via a local search algorithm. This method employs evolutionary sampling of the search space, deriving fitness terrain analysis results, and guiding the division direction and step size of the search space. Multiple search subspaces are segmented to enable parallel search for subsequent evolutionary calculations.

### TECHNICAL FIELD

The invention relates to the field of evolutionary solution technology, in particular to a parallel evolutionary solution method for search space segmentation.

### BACKGROUND ART

With the improvement of computing hardware, the optimization framework based on high-performance computing has developed rapidly. This framework, in addition to using intelligent (such as adaptive) search mechanisms, also relies on efficient computing resources, allowing algorithm programs to perform a large number of function evaluations within a certain period. Because the population of each generation of swarm intelligence search algorithm and the execution of each algorithm are independent of each other, the function evaluation calculation or independent algorithm call can be effectively executed on the distributed computing resources.

With the development of hardware technology, this distributed parallel computing method is becoming more and more simple, especially on the Linux operating system. Different programming languages also provide support for parallel computing, such as C++ language TBB technology support (Intel® Threading Building Blocks). For low-dimensional problems, such as two-dimensional problems, the entire search space can be regarded as a grid, each small grid corresponds to four sampling points, and the side length of the small grid is the grid sampling step size. However, this approach is powerless for high-dimensional problems and can only rely on high-performance computing.

### SUMMARY OF THE INVENTION

The purpose of the invention is to disclose a parallel evolutionary solution method for search space segmentation, based on the evolutionary sampling of the search space, the analysis results of the fitness terrain of the optimization problem are obtained, which is used to guide the division direction and step size of the search space, multiple search subspaces are segmented to support parallel search for subsequent evolutionary calculations.

In order to achieve the above purpose, the invention discloses a parallel evolutionary solution method for search space segmentation, comprising the following steps:
S1, randomly generating a solution scheme by a search space sampling and a space segmentation module, calculating a fitness value of a sample scheme by randomly generating initial sample schemes in the search space and combining an optimization objective function, carrying out a statistical screening of the sample scheme, obtaining a dimension direction K of a segmented search space, and segmenting the search space into several subspaces;
S2, executing a global search algorithm in the segmented subspaces to obtain a global initial solution scheme;
S3, taking the global initial solution scheme as a starting point, obtaining a precise solution scheme by a local search algorithm.

Preferably, in S1, the specific operation is as follows:
generating NS sample points in the global search space to explore a morphological distribution of a function space;
using an optimization objective function to evaluate all sample points, and obtaining an objective function value of all sample points, the objective function value is the fitness value, assuming that an optimization problem is a minimization optimization problem, sorting all sample points from small to large according to the objective function value, and retaining an individual population Ω of sample points with a function value ranking in the top 50%;
analyzing a component direction ϑ of a first principal component distributed in the population Ω by principal component analysis;
using a dimension K closest to ϑ as a separation dimension to separate the global search space and form several subspaces.

Preferably, in S2, the global search algorithm is a differential evolution algorithm based on case learning, and the differential evolution algorithm based on case learning adaptively adjusts the control parameters, comprising a scaling factor F and a crossover probability CR;
where a parameter pair refers to F and CR corresponding to each individual, in the differential evolution algorithm based on case learning, if a parameter pair can help an individual to generate a sub-individual with better objective function value, then the parameter pair is regarded as a successful case parameter, a successful case refers to the successful case parameter and the corresponding parent individuals.

Preferably, improved operators of differential evolution algorithms based on case learning comprise a retrieval-based mutation operator, a retrieval-based crossover operator, and a storage-based selection operator.

Preferably, for the i-th individual x_{i,G} in the current generation G, a corresponding mutation operator is expressed as:

$${v}_{i , G + 1} = {x}_{r 1 , G} + {x}_{i , G} \cdot F \times ( {x}_{r 2 , G} - {sx}_{r 3 , G} ) \qquad ( 1 )$$

where r1, r2, r3 denote integers, and r1, r3∈[1, NP], r2∈[1, NP×pbest], r1≠i, pbest∈(0,1] and NP×pbest>1; v_{i,G+1} denotes a mutation individual; x_{r1,G} denotes a first individual involved in a mutation; x_{r2,G} denotes a second individual involved in the mutation; sx_{r3,G} denotes a valuable individual stored from the first generation to the G−1-th generation; pbest denotes top p % best individuals in the population, pbest controls a balance between algorithm exploration and exploitation ability; NP denotes a population size; x_{i,G}·F denotes a mutation scaling factor corresponding to the individual x_{i,G} of the population;

a generation rule of x_{i,G}·F is as follows:

$${x}_{i , G} \cdot F = \{ \begin{matrix}Gau ( μ F , 1 ) , L ( S ) = 0 \\ {S}_{m} \cdot F , L ( S ) > 0\end{matrix} \qquad ( 2 )$$

where the function Gau(μF,1) outputs a normal distribution floating point number where μF is a mean value; according to an empirical value, assume μF=1; L(S) denotes a length of the container S, m∈[1, L(S)], Sₘ denotes an m-th successful case stored in the container S, and Sₘ·F refers to a mutation scaling factor corresponding to the m-th successful case;

the successful case is a case formed by the solution vector of the current population individual, F and CR when a pair of scaling factor F and crossover probability CR can help a population individual to find a sub-population individual with better function value, and

$$∀ j ∈ [ 1 , L ( S ) ] , d ( {S}_{m} \cdot v , {x}_{i , G} ) \leq d ( {S}_{j} \cdot v , {x}_{i , G} ) \qquad ( 3 )$$

if d(Sₘ·v, x_{i,G})>0.05 or

$$\frac{G}{{G}_{max}} > 0.5 ,$$

where F=0, where Gₘₐₓ denotes a maximum evolution algebra; Sⱼ denotes a j-th successful case stored in the container S; Sₘ·v denotes a solution vector corresponding to the j-th successful case stored in the container S if F overflows the boundary, the following update needs to be made:

$$F = r a n d ( 0 , 1 ] \qquad ( 4 )$$

updated F∈(0,1]; the rand function is used to generate random numbers between 0 and 1;

sx_{r3,G} is selected from a union A∪P of a self-replaced parent individual set A and a current population set P; a length of A is the same with P.

Preferably, an objective of a search-based crossover operator is to generate an intermediate solution:

$${u}_{i , G} = ( {u}_{1 , i , G} , … , {u}_{j , i , G} , … , {u}_{D , i , G} ) \qquad ( 5 )$$

where u_{i,G} denotes an intermediate solution generated by the i-th individual in the G generation, and u_{j,i,G} denotes a j-th element of the intermediate solution u_{i,G}; 1≤j≤D;

$${u}_{j , i , G} = \{ \begin{matrix}{u}_{j , i , G} , & rand ( 0 , 1 ) < CR or j = rand ( 1 , D ) \\ {x}_{j , i , G} , & rand ( 0 , 1 ) > CR and j \neq rand ( 1 , D )\end{matrix} \qquad ( 6 )$$

where x_{j,i,G} is an j-th element of the population individual x_{i,G};

a generation rule of x_{i,G}·CR is as follows:

$${x}_{i , G} \cdot CR = \{ \begin{matrix}Gau ( μ CR , 0.01 ) , L ( S ) = 0 \\ {S}_{m} \cdot CR , L ( S ) > 0\end{matrix} \qquad ( 7 )$$

and

$$∀ j ∈ [ 1 , L ( S ) ] , d ( {S}_{m} \cdot v , {x}_{i , G} ) \leq d ( {S}_{j} \cdot v , {x}_{i , G} ) if d ( {S}_{m} \cdot v , {x}_{i , G} ) > 0.05 or \frac{G}{{G}_{max}} > 0.5 , CR = 0. \qquad ( 3 )$$

Preferably, a storage-based selection operator is used to select individuals with better fitness values among parent individuals and sub-individuals, the specific operation is as follows:

$${x}_{i , G} = \{ \begin{matrix}{u}_{i , G} , & f ( {u}_{i , G} ) < f ( {x}_{i , G} ) \\ {x}_{i , G} , & otherwise\end{matrix} \qquad ( 8 )$$

replaced parent individuals are stored in the set A; if the set A is full, a new member will randomly replace an old member.

Preferably, in S3, the local search algorithm takes a starting point x₀ⁱⁿⁱ as an input, if the solution of the search result is better than the solution of the starting point, an output will be used as the starting point to re-invoke the local search algorithm and marked as x₁ⁱⁿⁱ;

the local search algorithm continuously learns gradient information in the local area of the target, a search accuracy is e, and a size of the local area is expressed as:

$$\{ \begin{matrix}{L}_{L}^{j} = {x}_{0 , j}^{ini} - e \\ {U}_{L}^{j} = {x}_{0 , j}^{ini} + e\end{matrix} \qquad ( 9 )$$

where L_{L}^{j} denotes a lower bound of the j-th sub-search space, U_{L}^{j} denotes an upper bound of the j-th sub-search space, and x_{0,j}ⁱⁿⁱ denotes an initial solution of the j-th sub-search space.

Therefore, the invention adopts the above-mentioned parallel evolutionary solution method for search space segmentation, and the technical effect is as follows:
(1) It makes full use of the computing resources of the equipment and greatly reduces the computing time.
(2) It improves the accuracy of the solution and the quality of solution evolutionary sampling based on search space.

The following is a further detailed description of the technical solution of the invention through drawings and an embodiment.

### BRIEF DESCRIPTION OF DRAWINGS

FIG. 1 is a frame diagram of the parallel evolutionary solution method for search space segmentation in the invention.

FIG. 2 is a schematic diagram of search space segmentation;

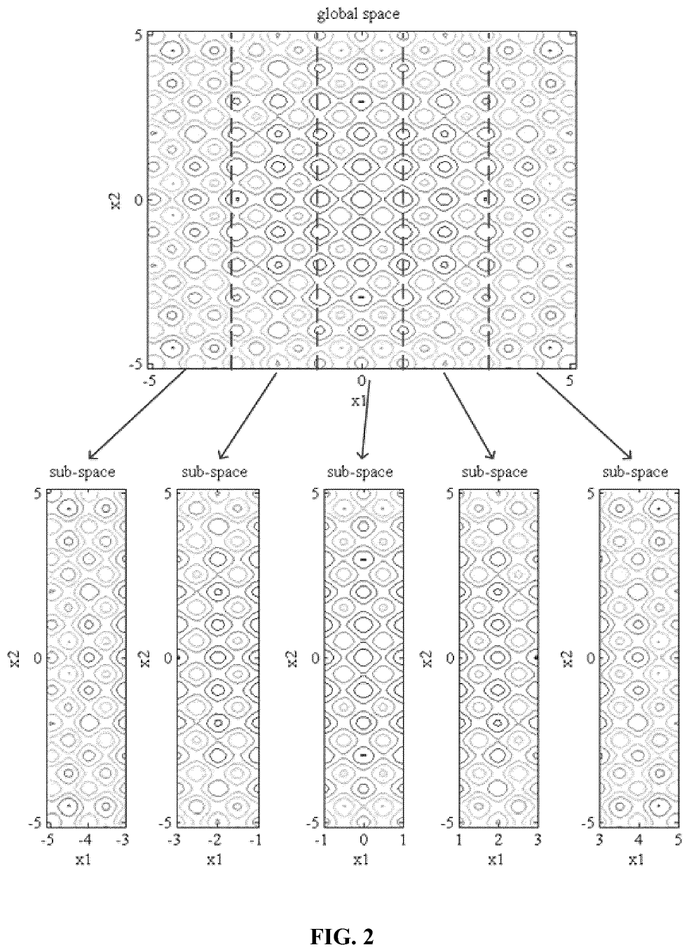

FIG. 3 is a simulation diagram of successful cases in the CLDE algorithm.

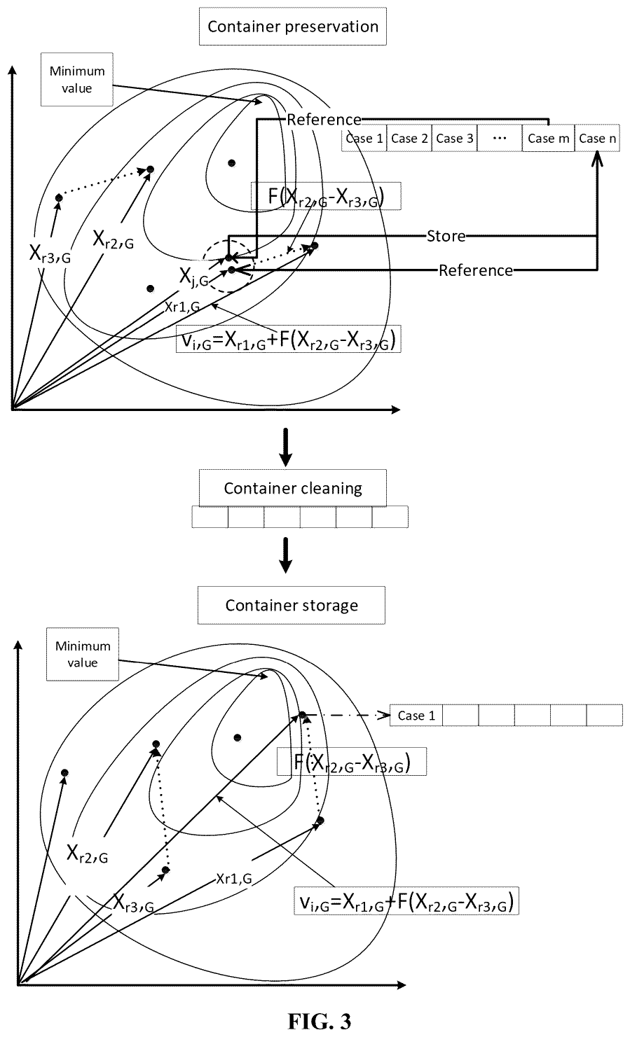

FIG. 4 shows an off-trap method and a gradient learning method of local search operator L-CLDE.

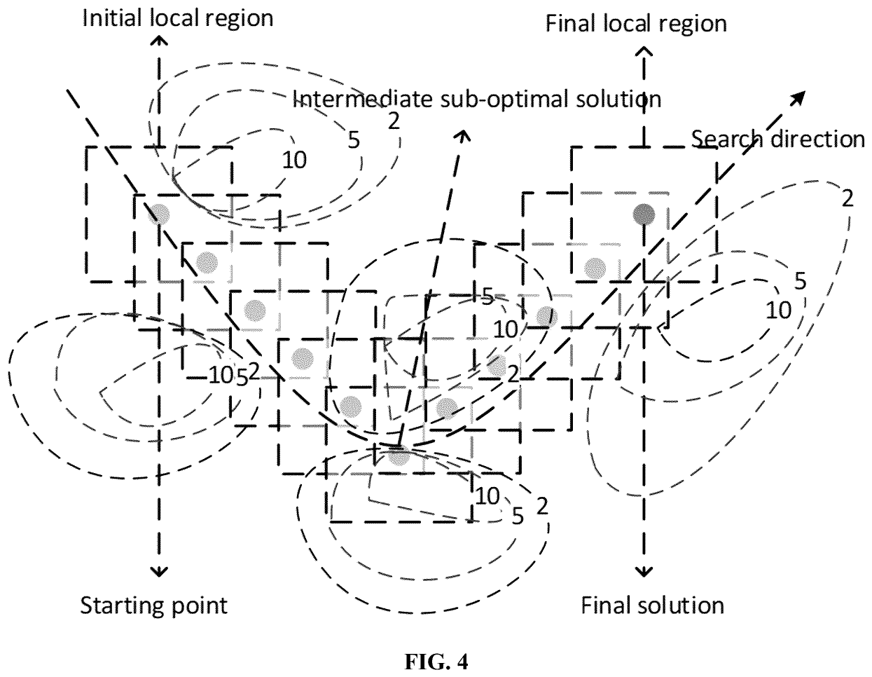

### DETAILED DESCRIPTION OF THE EMBODIMENTS

The following is a further explanation of the technical solution of the invention through drawings and embodiments.

Unless otherwise defined, the technical terms or scientific terms used in the invention should be understood by people with general skills in the field to which the invention belongs.

### Embodiment One

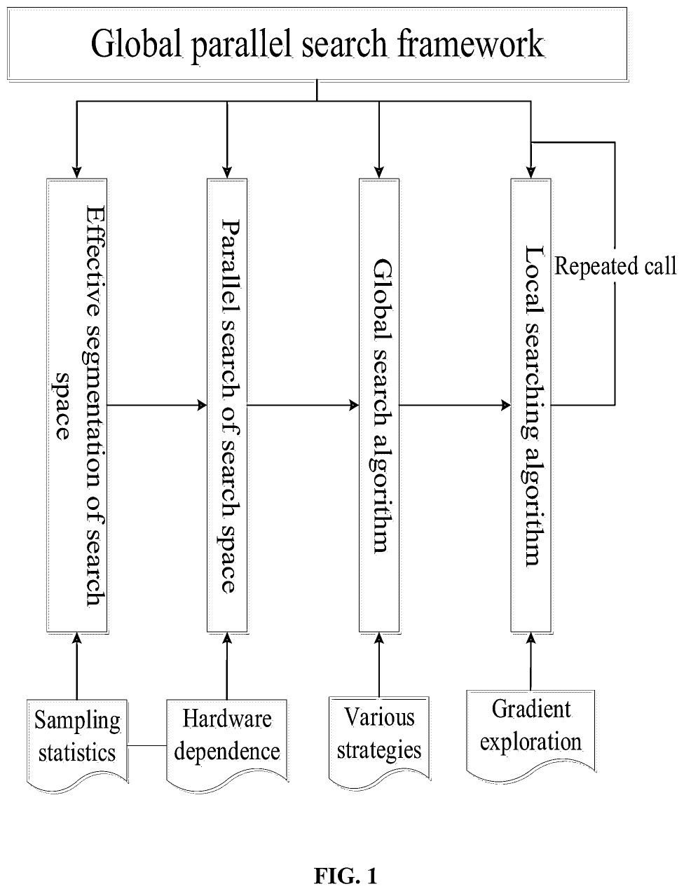

As shown in FIG. 1, it is the framework diagram of the parallel evolutionary solution method for the search space segmentation of the invention, comprising the following steps:
S1, randomly generating a solution scheme by a search space sampling and a space segmentation module, the fitness value of the sample scheme is calculated by randomly generating initial sample schemes in the search space and combining the optimization objective function, the statistical screening of the sample scheme is carried out to obtain the dimension direction K of the segmented search space, and the search space is segmented into several subspaces;
in S1, the specific operation is as follows:
NS sample points are generated in the global search space to explore the morphological distribution of the function space;
the optimization objective function is used to evaluate all sample points, and the objective function value of all sample points is obtained, the objective function value is the fitness value, assuming that the optimization problem is the minimization optimization problem, all sample points are sorted from small to large according to the objective function value, and the individual population Ω of sample points with a function value ranking in the top 50% is retained;
the component direction ϑ of the first principal component distributed in the population Ω is analyzed by principal component analysis;
the dimension K closest to ϑ is used as a separation dimension to separate the global search space and form several subspaces.
S2, the global search algorithm in the segmented subspaces is executed to obtain the global initial solution scheme;
the global search algorithm is a differential evolution algorithm based on case learning, and the differential evolution algorithm based on case learning adaptively adjusts the control parameters, comprising the scaling factor F and the crossover probability CR;
where a parameter pair refers to F and CR corresponding to each individual, in the differential evolution algorithm based on case learning, if a parameter pair can help an individual to generate the sub-individual with better objective function value, then the parameter pair is regarded as a successful case parameter, a successful case refers to the successful case parameter and the corresponding parent individuals.

The improved operators of the differential evolution algorithm based on case learning comprise a retrieval-based mutation operator, a retrieval-based crossover operator, and a storage-based selection operator.

For the i-th individual x_{i,G} in the current generation G, the corresponding mutation operator is expressed as:

$${v}_{i , G + 1} = {x}_{r 1 , G} + {x}_{i , G} \cdot F \times ( {x}_{r 2 , G} - s {x}_{r 3 , G} ) \qquad ( 1 )$$

where r1, r2, r3 denote integers, and r1, r3∈[1, NP], r2∈[1, NP×pbest], r1≠i, pbest∈(0,1] and NP×pbest>1; v_{i,G+1} denotes the mutation individual; x_{r1,G} denotes the first individual involved in a mutation; x_{r2,G} denotes the second individual involved in the mutation; sx_{r3,G} denotes the valuable individual stored from the first generation to the G−1-th generation; pbest denotes the top p % best individuals in the population, pbest controls the balance between algorithm exploration and exploitation ability; NP denotes the population size; x_{i,G}·F denotes the mutation scaling factor corresponding to the individual x_{i,G} of the population;
the generation rule of x_{i,G}·F is as follows:

$${x}_{i , G} \cdot F = \{ \begin{matrix}Gau ( μ F , 1 ) , L ( S ) = 0 \\ {S}_{m} \cdot F , L ( S ) > 0\end{matrix} \qquad ( 2 )$$

where the function Gau(μF,1) outputs the normal distribution floating point number where μF is the mean value; according to the empirical value, assume μF=1; L(S) denotes the length of the container S, m∈[1, L(S)], Sₘ denotes the m-th successful case stored in the container S, and Sₘ·F refers to the mutation scaling factor corresponding to the m-th successful case;
the successful case is a case formed by the solution vector of the current population individual, F and CR when the pair of scaling factor F and crossover probability CR can help a population individual to find the sub-population individual with better function value, and

$$∀ j ∈ [ 1 , L ( S ) ] , d ( {S}_{m} \cdot v , {x}_{i , G} ) \leq d ( {S}_{j} \cdot v , {x}_{i , G} ) \qquad ( 3 )$$

if d(Sₘ·v, x_{i,G})>0.05 or

$$\frac{G}{{G}_{max}} > 0.5 ,$$

F=0, where Gₘₐₓ denotes the maximum evolution algebra; Sⱼ denotes the j-th successful case stored in the container S; Sₘ·v denotes the solution vector corresponding to the j-th successful case stored in the container S if F overflows the boundary, the following update needs to be made:

$$F = r a n d ( 0 , 1 ] \qquad ( 4 )$$

updated F∈(0,1]; the rand function is used to generate random numbers between 0 and 1;
sx_{r3,G} is selected from the union A∪P of the self-replaced parent individual set A and the current population set P; the length of A is the same with P.

The objective of the search-based crossover operator is to generate the intermediate solution:

$${u}_{i , G} = ( {u}_{1 , i , G} , … , {u}_{j , i , G} , … , {u}_{D , i , G} ) \qquad ( 5 )$$

where u_{i,G} denotes the intermediate solution generated by the i-th individual in the G generation, and u_{j,i,G} denotes the j-th element of the intermediate solution u_{i,G}; 1≤j≤D;

$${u}_{j , i , G} = \{ \begin{matrix}{u}_{j , i , G} , & rand ( 0 , 1 ) < CR or j = rand ( 1 , D ) \\ {x}_{j , i , G} , & rand ( 0 , 1 ) > CR and j \neq rand ( 1 , D )\end{matrix} \qquad ( 6 )$$

where x_{j,i,G} is the j-th element of the population individual x_{i,G};
the generation rule of x_{i,G}·CR is as follows:

$${x}_{i , G} \cdot CR = \{ \begin{matrix}Gau ( μ CR , 0.01 ) , L ( S ) = 0 \\ {S}_{m} \cdot CR , L ( S ) > 0\end{matrix} \\ and \qquad ( 7 )$$

$$∀ j ∈ [ 1 , L ( S ) ] , d ( {S}_{m} \cdot v , {x}_{i , G} ) \leq d ( {S}_{j} \cdot v , {x}_{i , G} ) if d ( {S}_{m} \cdot v , {x}_{i , G} ) > 0.05 or \frac{G}{{G}_{max}} > 0.5 , CR = 0. \qquad ( 3 )$$

The storage-based selection operator is used to select individuals with better fitness values among parent individuals and sub-individuals, the specific operation is as follows:

$${x}_{i , G} = \{ \begin{matrix}{u}_{i , G} , & f ( {u}_{i , G} ) < f ( {x}_{i , G} ) \\ {x}_{i , G} , & otherwise\end{matrix} \qquad ( 8 )$$

the replaced parent individuals are stored in the set A; if the set A is full, the new member will randomly replace an old member.
S3, the global initial solution scheme is taken as the starting point, the precise solution scheme is obtained by the local search algorithm.
in S3, the local search algorithm takes the starting point x₀ⁱⁿⁱ as the input, if the solution of the search result is better than the solution of the starting point, the output will be used as the starting point to re-invoke the local search algorithm and marked as x₁ⁱⁿⁱ;
the local search algorithm continuously learns gradient information in the local area of the target, the search accuracy is e, and the size of the local area is expressed as:

$$\{ \begin{matrix}{L}_{L}^{j} = {x}_{0 , j}^{ini} - e \\ {U}_{L}^{j} = {x}_{0 , j}^{ini} + e\end{matrix} \qquad ( 9 )$$

where L_{L}^{j} denotes the lower bound of the j-th sub-search space, U_{L}^{j} denotes the upper bound of the j-th sub-search space, and x_{0,j}ⁱⁿⁱ denotes the initial solution of the j-th sub-search space.

The following explains the method proposed by the invention through specific examples:

The application problem is a typical problem in the spacecraft orbit design problem set GTOP, comprising Cassini1, GTOC1, Messenger (full), Cassini2, and Rosetta problems, the comparison algorithm is the global optimization algorithm in the PYGMO software package. The parameter information of all comparison algorithms is given in Table 1, it is worth noting that these parameters are necessary and fixed parameters in the comparison algorithm, and the default values of the parameters preset by PYGMO are used. In order to ensure fairness, the PYGMO algorithm is only compared with the G-CLDE algorithm, and the same number of maximum function evaluation times is set. In comparison with the PYGMO algorithm, the G-CLDE population size is 200, the algebra is 800, and a total of 160,000 function evaluations. The algorithm is executed independently 30 times, and the search results of the algorithm on each problem are counted. Table 2 shows the best solution, the worst solution, the mean solution, and the variance of all algorithms found in 30 independent experiments.

In order to further evaluate the comprehensive performance of all algorithms on GTOP multiple problems, the Friedman evaluation method is used to calculate the ranking value of all algorithms on the optimal solution and mean solution found. The Friedman test results of the G-CLDE and PYGMO algorithms on the GTOP problem are given in Table 3 and Table 4, respectively, the optimal solution and the mean solution in 30 independent experiments are used as the analysis data. From the test results, it can be seen that G-CLDE has the best test performance, and the advantage is obvious whether it is from the optimal solution found or from the mean value of multiple experiments. Compared with other algorithms, G-CLDE makes it difficult to find the best-known solution to the Cassini1 problem, which is also the main disadvantage of the G-CLDE algorithm. On the Rosetta problem, MDE_pBx has the best search performance, and the best solution found is also very close to the currently known best solution. The best solution found by the G-CLDE algorithm on GTOC1 is also close to the best solution currently known, and it shows obvious advantages on the most complex GTOP problems, namely Messenger (full) and Cassini2. Although the 6.970 km/s found on the Messenger (full) problem is still far from the currently known optimal solution, the search moral results within 160,000 function evaluations also show that G-CLDE has strong global search performance.

TABLE 1
Parameter settings of the PYGMO algorithm

| Algorithm | Parameter settings |
|---|---|
| GA | r = 0.2; NP = 200; Maxgen = 800 |
| MDE_pBx | Maxgen = 2000; percentage = 0.15; meanexponent = 1.5; ftol = 1e−030; |
| | xtol = 1e−030; |
| DE | Maxgen = 800; NP = 200; F = 0.5; CR = 0.9 |
| PSO | c1 = 2; c2 = 2; w = 1.4; Maxgen = 800; NP = 200 |
| JDE | Maxgen = 800; NP = 200; F = 0.5; CR = 0.9 |
| DE-1220 | Maxgen = 800; NP = 200; F = 0.5; CR = 0.9 |
| GAGE | Maxgen = 800; NP = 200; M = 0.02; CR = 0.95; elitism = 1; selection: |
| | ROULETTE |
| SA | iter = 160000; Ts = 1; Tf = 0.01; steps = 1; binsize = 20; range = 1 |
| IHS | iter = 160000; phmcr = 0.85; ppar − min = 0.35; ppar − max = 0.99; |
| | bw − min = 1e−005; bw − max = 1 |
| CMA-ES | cc = −1; cs = −1; c1 = −1; cmu = −1; sigma0 = 0.5; ftol = 1e−030; |
| | xtol = 1e−030 memory = 0 |
| ABC | Gₘₐₓ = 800; limit = 20 |
| G-CLDE | Gr = 2; NP = 200; Gₘₐₓ = 800 |

TABLE 2
performance comparison of algorithms

| | | Optimal | Worst | Average | Standard |
|---|---|---|---|---|---|
| Problem | Algorithm | solution | solution | solution | deviation |
| Cassini1 | PSO | 5.136 | 11.316 | 6.315 | 1.972 |
| Cassini1 | GAGE | 5.340 | 8.261 | 5.552 | 0.509 |
| Cassini1 | MDE_pBx | 5.303 | 12.529 | 8.877 | 2.950 |
| Cassini1 | JDE | 5.303 | 10.997 | 5.493 | 1.080 |
| Cassini1 | DE | 5.303 | 10.996 | 5.493 | 1.080 |
| Cassini1 | DE-1220 | 4.931 | 17.267 | 8.720 | 3.703 |
| Cassini1 | SA | 5.323 | 34.269 | 14.821 | 7.067 |
| Cassini1 | IHS | 5.308 | 5.318 | 5.312 | 0.002 |
| Cassini1 | GA | 5.542 | 18.162 | 13.623 | 3.741 |
| Cassini1 | CMA-ES | 10.996 | 16.711 | 15.882 | 1.939 |
| Cassini1 | ABC | 5.857 | 8.612 | 6.634 | 0.579 |
| Cassini1 | G-CLDE | 5.303 | 9.104 | 6.310 | 1.348 |
| GTOC1 | PSO | −1249559 | −767819 | −973620 | 136940 |
| GTOC1 | GAGE | −1446170 | −44413 | −523095 | 376309 |
| GTOC1 | MDE_pBx | −1534122 | −736976 | −1119492 | 192452 |
| GTOC1 | JDE | −1143012 | −703533 | −858395 | 92121 |
| GTOC1 | DE | −941092 | −628385 | −766918 | 90299 |
| GTOC1 | DE-1220 | −1332440 | −379466 | −862324 | 231545 |
| GTOC1 | SA | −594980 | −2643 | −136733 | 168101 |
| GTOC1 | IHS | −1251165 | −771673 | −1063535 | 109637 |
| GTOC1 | GA | −992630 | −24424 | −340944 | 311303 |
| GTOC1 | CMA-ES | −1173595 | −133596 | −690969 | 362343 |
| GTOC1 | ABC | −992941 | −614104 | −784109 | 90779 |
| GTOC1 | G-CLDE | −1571816 | −996044 | −1227431 | 135208 |
| Rosetta | PSO | 2.130 | 5.913 | 3.744 | 1.019 |
| Rosetta | GAGE | 4.827 | 15.436 | 10.589 | 2.880 |
| Rosetta | MDE_pBx | 1.344 | 4.199 | 2.260 | 0.803 |
| Rosetta | JDE | 3.240 | 7.892 | 5.989 | 1.219 |
| Rosetta | DE | 2.972 | 9.569 | 7.428 | 0.917 |
| Rosetta | DE-1220 | 1.485 | 12.299 | 5.356 | 3.202 |
| Rosetta | SA | 1.578 | 15.515 | 5.515 | 3.272 |
| Rosetta | IHS | 2.548 | 8.690 | 4.268 | 1.509 |
| Rosetta | GA | 2.978 | 15.699 | 8.459 | 2.835 |
| Rosetta | CMA-ES | 1.885 | 5.363 | 2.441 | 1.104 |
| Rosetta | ABC | 3.728 | 8.980 | 6.375 | 1.378 |
| Rosetta | G-CLDE | 1.373 | 4.462 | 2.369 | 0.902 |
| Messenger(full) | PSO | 9.889 | 15.699 | 13.486 | 1.673 |
| Messenger(full) | GAGE | 12.944 | 33.668 | 21.558 | 4.555 |
| Messenger(full) | MDE_pBx | 12.061 | 17.081 | 14.990 | 1.182 |
| Messenger(full) | JDE | 11.083 | 19.676 | 16.366 | 2.184 |
| Messenger(full) | DE | 12.716 | 20.465 | 17.818 | 1.552 |
| Messenger(full) | DE-1220 | 10.134 | 20.291 | 15.996 | 2.238 |
| Messenger(full) | SA | 10.163 | 22.495 | 15.218 | 3.077 |
| Messenger(full) | IHS | 14.767 | 16.427 | 16.041 | 0.378 |
| Messenger(full) | GA | 13.275 | 20.824 | 16.662 | 1.955 |
| Messenger(full) | CMA-ES | 12.366 | 16.152 | 14.089 | 1.151 |
| Messenger(full) | ABC | 10.429 | 19.160 | 15.797 | 1.686 |
| Messenger(full) | G-CLDE | 6.970 | 16.468 | 12.763 | 2.838 |
| Cassini2 | PSO | 12.215 | 20.365 | 15.745 | 1.951 |
| Cassini2 | GAGE | 12.289 | 30.032 | 22.941 | 4.436 |
| Cassini2 | MDE_pBx | 13.914 | 21.186 | 18.829 | 1.988 |
| Cassini2 | JDE | 13.876 | 20.624 | 17.265 | 1.842 |
| Cassini2 | DE | 11.189 | 22.488 | 19.532 | 1.944 |
| Cassini2 | DE-1220 | 9.167 | 27.202 | 18.992 | 3.975 |
| Cassini2 | SA | 13.393 | 31.444 | 19.608 | 3.615 |
| Cassini2 | IHS | 10.064 | 24.552 | 19.559 | 3.254 |
| Cassini2 | GA | 14.377 | 28.838 | 20.220 | 9.465 |
| Cassini2 | CMA-ES | 15.438 | 21.088 | 19.818 | 1.440 |
| Cassini2 | ABC | 11.627 | 20.412 | 16.403 | 2.525 |
| Cassini2 | G-CLDE | 8.667 | 21.566 | 13.909 | 3.600 |

TABLE 3
Friedman test results of the optimal solution
found by G-CLDE and PYGMO algorithms
on the GTOP problem

| | Ranking |
|---|---|
| Algorithm | score |
| PSO | 4.4 |
| MAGA | 8.2 |
| MDE_pBx | 4.9 |
| JDE | 7.5 |
| DE | 7.3 |
| DE-1220 | 2.6 |
| SA | 7.2 |
| IHS | 6.8 |
| GA | 10.2 |
| CMA-ES | 8.8 |
| ABC | 8.2 |
| G-CLDE | 1.9 |

TABLE 4
Friedman test results of the mean value solutions
found by G-CLDE and PYGMO algorithms
on GTOP problems

| | Ranking |
|---|---|
| Algorithm | score |
| PSO | 3.6 |
| MAGA | 10 |
| MDE_pBx | 4.2 |
| JDE | 5.9 |
| DE | 7.7 |
| DE-1220 | 6.4 |
| SA | 8.8 |
| IHS | 5 |
| GA | 10.6 |
| CMA-ES | 7.4 |
| ABC | 6.4 |
| G-CLDE | 2 |

TABLE 5
Validity results of L-CLDE
algorithm with G-CLDE

| | Improvement |
|---|---|
| Problem | by L-CLDE |
| Cassini1 | 4.62E−04 |
| Cassini2 | 1.2183 |
| GTOC1 | 1.17E+03 |
| Messenger(reduced) | 0.3856 |
| Messenger(full) | 0.2284 |
| Rosetta | 0.4712 |

In order to test the performance of the L-CLDE algorithm on the GTOP problem, the G-CLDE and L-CLDE algorithms are connected, that is, the output of the G-CLDE is used as the input of the L-CLDE algorithm. The population sizes of the G-CLDE algorithm and the L-CLDE algorithm are set to be 200, the evolution algebras are 1200 and 500, and the number of independent experiments is 100. It is worth noting that because the L-CLDE algorithm will be called repeatedly, in fact, the number of function evaluations required by the L-CLDE algorithm will be higher than 100,000 times. The difference between the average output value of the G-CLDE algorithm and the average output value of the L-CLDE algorithm in 30 independent experiments is used as the improvement of the search results of the L-CLDE algorithm relative to the G-CLDE algorithm. The detailed results are shown in Table 5. From the test results, it can be seen that the L-CLDE algorithm makes it difficult to improve the results of the G-CLDE algorithm on the simplest Cassini1 problem. On the issue of Cassini2, the improvement is the most obvious.

Therefore, the invention adopts the above-mentioned parallel evolutionary solution method for search space segmentation, it makes full use of the computing resources of the equipment, greatly reduces the computing time, improves the accuracy of the solution, and improves the quality of the solution.

Finally, it should be explained that the above embodiment is only used to explain the technical solution of the invention rather than restrict it. Although the invention is described in detail concerning the better embodiment, the ordinary technical personnel in this field should understand that they can still modify or replace the technical solution of the invention, and these modifications or equivalent substitutions cannot make the modified technical solution out of the spirit and scope of the technical solution of the invention.

What is claimed is:

1. A parallel evolutionary solution method for search space segmentation, comprising the following steps:
S1, randomly generating a solution scheme by a search space sampling and a space segmentation module, calculating a fitness value of a sample scheme by randomly generating initial sample schemes in the search space and combining an optimization objective function, carrying out a statistical screening of the sample scheme, obtaining a dimension direction K of a segmented search space, and segmenting the search space into several subspaces;
S2, executing a global search algorithm in the segmented subspaces to obtain a global initial solution scheme;
S3, taking the global initial solution scheme as a starting point, obtaining a precise solution scheme by a local search algorithm.

2. The parallel evolutionary solution method for search space segmentation according to claim 1, wherein in S1, the specific operation is as follows:
generating NS sample points in the global search space to explore a morphological distribution of a function space;
using an optimization objective function to evaluate all sample points, and obtaining an objective function value of all sample points, the objective function value is the fitness value, assuming that an optimization problem is a minimization optimization problem, sorting all sample points from small to large according to the objective function value, and retaining an individual population Ω of sample points with a function value ranking in the top 50%;
analyzing a component direction ϑ of a first principal component distributed in the population Ω by principal component analysis;
using a dimension K closest to ϑ as a separation dimension to separate the global search space and form several subspaces.

3. The parallel evolutionary solution method for search space segmentation according to claim 2, wherein in S2, a global search algorithm is a differential evolution algorithm based on case learning, and the differential evolution algorithm based on case learning adaptively adjusts the control parameters, comprising a scaling factor F and a crossover probability CR;
where a parameter pair refers to F and CR corresponding to each individual, in the differential evolution algorithm based on case learning, if a parameter pair can help an individual to generate a sub-individual with better objective function value, then the parameter pair is regarded as a successful case parameter, a successful case refers to the successful case parameter and the corresponding parent individuals.

4. The parallel evolutionary solution method for search space segmentation according to claim 3, wherein improved operators of differential evolution algorithm based on case learning comprise a retrieval-based mutation operator, a retrieval-based crossover operator, and a storage-based selection operator.

5. The parallel evolutionary solution method for search space segmentation according to claim 4, wherein for an i-th individual x_{i,G} in a current generation G, a corresponding mutation operator is expressed as:
$${v}_{i , G + 1} = {x}_{r 1 , G} + {x}_{i , G} \cdot F \times ( {x}_{r 2 , G} - s {x}_{r 3 , G} ) \qquad ( 1 )$$
where r1, r2, r3 denote integers, and r1, r3∈[1, NP], r2∈[1, NP×pbest], r1≠i, pbest∈(0,1] and NP×pbest>1; v_{i,G+1} denotes a mutation individual; x_{r1,G} denotes a first individual involved in a mutation; x_{r2,G} denotes a second individual involved in the mutation; sx_{r3,G} denotes a valuable individual stored from the first generation to the G−1-th generation; pbest denotes top p % best individuals in the population, pbest controls a balance between algorithm exploration and exploitation ability; NP denotes a population size; x_{i,G}·F denotes a mutation scaling factor corresponding to the individual x_{i,G} of the population;
a generation rule of x_{i,G}·F is as follows:
$${x}_{i , G} \cdot F = \{ \begin{matrix}Gau ( μ F , 1 ) , L ( S ) = 0 \\ {S}_{m} \cdot F , L ( S ) > 0\end{matrix} \qquad ( 2 )$$
where the function Gau(μF,1) outputs a normal distribution floating point number where μF is a mean value; according to an empirical value, assume μF=1; L(S) denotes a length of the container S, m∈[1, L(S)], Sₘ denotes a m-th successful case stored in the container S, and Sₘ·F refers to a mutation scaling factor corresponding to the m-th successful case;
the successful case is a case formed by the solution vector of the current population individual, F and CR when a pair of scaling factor F and crossover probability CR can help a population individual to find a sub-population individual with better function value, and
$$∀ j ∈ [ 1 , L ( S ) ] , d ( {S}_{m} . v , {x}_{i , G} ) \leq d ( {S}_{j} \cdot v , {x}_{i , G} ) \qquad ( 3 )$$
if d(Sₘ·v, x_{i,G})>0.05 or
$$\frac{G}{{G}_{max}} > 0.5 ,$$
F=0, where Gₘₐₓ denotes a maximum evolution algebra; Sⱼ denotes a j-th successful case stored in the container S; Sₘ·v denotes a solution vector corresponding to the j-th successful case stored in the container S if F overflows the boundary, the following update needs to be made:
$$F = r a n d ( 0 , 1 ] \qquad ( 4 )$$
updated F∈(0,1]; the rand function is used to generate random numbers between 0 and 1;
sx_{r3,G} is selected from a union A∪P of a self-replaced parent individual set A and a current population set P; a length of A is the same with P.

6. The parallel evolutionary solution method for search space segmentation according to claim 5, wherein an objective of a search-based crossover operator is to generate an intermediate solution:
$${u}_{i , G} = ( {u}_{1 , i , G} , … , {u}_{j , i , G} , … , {u}_{D , i , G} ) \qquad ( 5 )$$
where u_{i,G} denotes an intermediate solution generated by the i-th individual in the G generation, and u_{j,i,G} denotes a j-th element of the intermediate solution u_{i,G}; 1≤j≤D;
$${u}_{j , i , G} = \{ \begin{matrix}{u}_{j , i , G} , & rand ( 0 , 1 ) < CR or j = rand ( 1 , D ) \\ {x}_{j , i , G} , & rand ( 0 , 1 ) > CR and j \neq rand ( 1 , D )\end{matrix} \qquad ( 6 )$$
where x_{j,i,G} is an j-th element of the population individual x_{i,G};
a generation rule of x_{i,G}·CR is as follows:
$${x}_{i , G} \cdot CR = \{ \begin{matrix}Gau ( μ CR , 0.01 ) , L ( S ) = 0 \\ {S}_{m} \cdot CR , L ( S ) > 0\end{matrix} \qquad ( 7 )$$
and
$$∀ j ∈ [ 1 , L ( S ) ] , d ( {S}_{m} \cdot v , {x}_{i , G} ) \leq d ( {S}_{j} \cdot v , {x}_{i , G} ) if d ( {S}_{m} \cdot v , {x}_{i , G} ) > 0.05 or \frac{G}{{G}_{max}} > 0.5 , CR = 0. \qquad ( 3 )$$

7. The parallel evolutionary solution method for search space segmentation according to claim 6, wherein a storage-based selection operator is used to select individuals with better fitness values among parent individuals and sub-individuals, the specific operation is as follows:
$${x}_{i , G} = \{ \begin{matrix}{u}_{i , G} , & f ( {u}_{i , G} ) < f ( {x}_{i , G} ) \\ {x}_{i , G} , & otherwise\end{matrix} \qquad ( 8 )$$
replaced parent individuals are stored in the set A; if the set A is full, a new member will randomly replace an old member.

8. The parallel evolutionary solution method for search space segmentation according to claim 7, wherein in S3, the local search algorithm takes a starting point x₀ⁱⁿⁱ as an input, if the solution of the search result is better than the solution of the starting point, an output will be used as the starting point to re-invoke the local search algorithm and marked as x₁ⁱⁿⁱ;
the local search algorithm continuously learns gradient information in the local area of the target, a search accuracy is e, and a size of the local area is expressed as:
$$\{ \begin{matrix}{L}_{L}^{j} = {x}_{0 , j}^{ini} - e \\ {U}_{L}^{j} = {x}_{0 , j}^{ini} + e\end{matrix} \qquad ( 9 )$$
where L_{L}^{j} denotes a lower bound of the j-th sub-search space, U_{L}ⁱ denotes an upper bound of the j-th sub-search space, and x_{0,j}ⁱⁿⁱ denotes an initial solution of the j-th sub-search space.
